(19) United States
(12) Patent Application Publication
(10) Pub. No.: US 2026/0325400 A1
(43) Pub. Date: Oct. 22, 2026

(54) PROXIMITY AND/OR TOUCH ACTIVATED DEVICE FOR DELIVERING A DESIRED EFFECT TO A BODY

(71) Applicant: Thomas William David Ashcroft, Granby (CA)

(72) Inventor: Thomas William David Ashcroft, Granby (CA)

(21) Appl. No.: 19/723,696

(22) Filed: Jun. 29, 2026

Related U.S. Application Data
(63) Continuation-in-part of application No. 18/197,064, filed on May 13, 2023, now abandoned.
(60) Provisional application No. 63/342,556, filed on May 16, 2022.

(51) Int. Cl. A61H 23/02; G06F 3/01

(52) U.S. Cl. CPC A61H 23/0254; G06F 3/017; A61H 2201/5084

(57) ABSTRACT

A device that activates when it is near or touching human skin even if clothing is present. The device uses a discrimination sensor and discrimination circuitry to confirm that the contact surface sensed is human skin rather than another material/object. The device provides for multiple desired effects to be applied to the skin/body. The device allows the user to control those desired effects through a gesture and a gesture area instead of a mechanical button.

### CROSS-REFERENCE TO RELATED APPLICATIONS

This patent application is a continuation-in-part of copending U.S. nonprovisional patent application Ser. No. 18/197,064, filed May 13, 2023 that claims the benefit of priority of U.S. Provisional Patent Application No. 63/342,556, filed on May 16, 2022, each of which is incorporated by reference herein in its entirety. This patent application is also related to U.S. Design Patent D1,065,558, which is incorporated by reference herein in its entirety.

### FIELD

The present invention generally relates to a proximity and/or touch activated device. More specifically, the invention relates to a proximity and/or skin touch activated device that delivers one or more desired effects to a body base on what physical properties are sensed by the device's discrimination sensor and a specific gesture provided by the user.

### BACKGROUND

Numerous devices exist that provide pleasurable, therapeutic or healing effects to the human body. These devices range from massaging devices that deliver vibrations or motion to a portion of the body to medical devices that deliver electrical current, heat, light, etc. to portions of the body. Inherently these devices all include some sort of switch or activation mechanism that activates the device to deliver the desired effect. Traditionally the switches used with these devices have been pressure-based switches where a portion of the switch is moved between an “on” state and an “off” state. If the device that is delivering the desired effect is untethered from an electrical outlet, the device usually incorporates a battery. For small devices, such as one that may only exist on a finger, the ability to house batteries is limited. Turning the device on and off can be cumbersome to conserve battery power. Also, for some medical devices, the user may only want the device on when the device is in close proximity to the skin so as not to accidentally deliver the therapeutic or healing effect, such as light, to the patient's or clinician's eyes where the light could be a detriment. For devices used in intimate activities, turning a device on and off during the intimate moment can detract from that intimate moment, therefore a more automated way of turning the device on and off would add to the spontaneity of the moment.

The main objective of the present invention is to provide a device actuation mechanism that allows a user the opportunity to both conserve battery power and deliver desired effects to the body only when needed without having to manually turn a switch on and off.

### SUMMARY

In one implementation, the present disclosure is directed to a device for delivering a desired effect to a body having skin. The device comprises a housing, a capacitive switch integrated with the housing, and a desired effect generating element integrated with the housing. When the capacitive switch is moved to within at least one from the group consisting of close proximity to the skin and touching the skin, the desired effect generating element is activated to generate a desired response that is transmitted to the skin and/or body.

In another implementation, the present disclosure is directed to a device for delivering a desired effect to a body having skin. The device comprises a housing and a desired effect generating element integrated with the housing. When the housing is moved to touch the skin, the desired effect generating element is activated to generate a desired response that is transmitted to the skin and/or without pressing any switch to activate the desired effect generating element.

In yet another implementation, the present disclosure is directed to a device for delivering a desired effect to a body by a user. The device comprises a housing having a sensory end a gesture end. The sensory end has a sensory area. A discrimination sensor is electrically connected to the sensory area. The discrimination sensor senses physical properties of the body when the discrimination sensor is at least one from the group including in close proximity to or touching the body. The discrimination sensor generates physical property data about the body. The device further includes a discrimination circuit electrically connected to the discrimination sensor and responds to the physical property data generated by the discrimination sensor to determine physical properties of the body. The device also includes a desired effect generating element within the housing that produces a plurality of desired effects. A gesture sensor is integrated with the gesture control end sensing one or more gestures of the user, the gesture sensor integrated to generate gesture data. A polymeric outer covering covers the housing, discrimination sensor and the gesture sensor. The desired effect generating element is activated to generate a desired effect base on both or either the physical property data and the gesture data.

In yet another implementation, the present disclosure is directed to a device for delivering a desired effect to a body by a user. The device comprises a housing having a sensory area and a gesture controller. A discrimination sensor is electrically connected to the sensory area. The discrimination sensor senses physical properties of the body when the discrimination sensor is at least one from the group including in close proximity to or touching the body. The discrimination sensor generates physical property data about the body. The device further includes a discrimination circuit electrically connected to the discrimination sensor. The discrimination circuit interprets the physical property data generated by the discrimination sensor to determine physical properties of the body. The device also includes a desired effect generating element within the housing that produces a plurality of desired effects. A gesture sensor is integrated with the gesture control end sensing one or more gestures of the user; the gesture sensor is integrated to generate gesture data. A polymeric outer covering covers the housing, discrimination sensor and the gesture sensor. The desired effect generating element is activated to generate a desired effect base on both or either the physical property data and the gesture data.

In still yet another implementation, the present disclosure is directed to a device for delivering a desired effect to a body by a user. The device comprises a housing having a sensory area and a gesture controller. The device also includes a desired effect generating element within the housing that produces a plurality of desired effects. A gesture sensor is integrated with the gesture control end sensing one or more gestures of the user; the gesture sensor is integrated to generate gesture data. The desired effect generating element is activated to generate a desired effect base on the physical property data and the gesture data.

### BRIEF DESCRIPTION OF DRAWINGS

For the purposes of illustrating the invention, the drawings show aspects of one or more embodiments of the invention. However, it should be understood that the present invention is not limited to the precise arrangements and instrumentalities shown in the drawings, wherein:

FIG. 1 is a perspective view showing a device for delivering a desired effect to a body in accordance with one embodiment of the present invention, the device in this embodiment is attached to a finger and touching skin;

FIG. 2 is a top perspective view of the device in FIG. 1;

FIG. 3 is bottom perspective view of the device in FIG. 2;

FIG. 4 is a front view of the device in FIG. 2;

FIG. 5 is a back view of the device in FIG. 2;

FIG. 6 is a left side view of the device in FIG. 2;

FIG. 7 is a right side view of the device in FIG. 2;

FIG. 8 is a top view of the device in FIG. 2;

FIG. 9 is a bottom view of the device in FIG. 2;

FIG. 10 is a left side, sectional view along line 10-10 of the device in FIG. 2;

FIG. 11 is an exploded view of the device in FIG. 2;

FIG. 12 is a circuit that may be integrated within the device in FIG. 2, the circuit controlling components of the device;

FIG. 13a is an enlarged view of the section 13a of the circuit diagram illustrated in FIG. 12;

FIG. 13b is an enlarged view of the section 13b of the circuit diagram illustrated in FIG. 12;

FIG. 13c is an enlarged view of the section 13c of the circuit diagram illustrated in FIG. 12;

FIG. 13d is an enlarged view of the section 13d of the circuit diagram illustrated in FIG. 12;

FIG. 13e is an enlarged view of the section 13e of the circuit diagram illustrated in FIG. 12;

FIG. 13f is an enlarged view of the section 13f of the circuit diagram illustrated in FIG. 12;

FIG. 13g is an enlarged view of the section 13g of the circuit diagram illustrated in FIG. 12;

FIG. 14a is an alternative embodiment illustrating a vibrating glove device incorporating the touch sensitive activation mechanism incorporated in FIGS. 10-13g;

FIG. 14b is an alternative embodiment illustrating a therapeutic light wand device incorporating the touch sensitive activation mechanism incorporated in FIGS. 10-13g;

FIG. 14c is an alternative embodiment illustrating a vibrator device incorporating the touch sensitive activation mechanism incorporated in FIGS. 10-13g;

FIG. 14d is an alternative embodiment illustrating a sex toy device incorporating the touch sensitive activation mechanism incorporated in FIGS. 10-13g;

FIG. 14e is an alternative embodiment illustrating a massager device incorporating the touch sensitive activation mechanism incorporated in FIGS. 10-13g;

FIG. 14f is an alternative embodiment illustrating an electrolysis pen device incorporating the touch sensitive activation mechanism incorporated in FIGS. 10-13g.

FIG. 15 is a perspective view showing a device for delivering a desired effect to a body in accordance with one embodiment of the present invention, the device in this embodiment is a vibration device that senses body properties using a discrimination sensor, a discrimination circuit, and applies a desired effect based on the sensed body properties and a gesture provided by the user;

FIG. 16 is a perspective view of the device in FIG. 15, now with the polymeric outer covering removed and showing the sensor areas;

FIG. 17 is a perspective view of the device in FIG. 15, now with the upper housing removed to show internal components; and

FIG. 18 is sectional view along 18-18 of FIG. 15 showing internal components.

### DETAILED DESCRIPTION

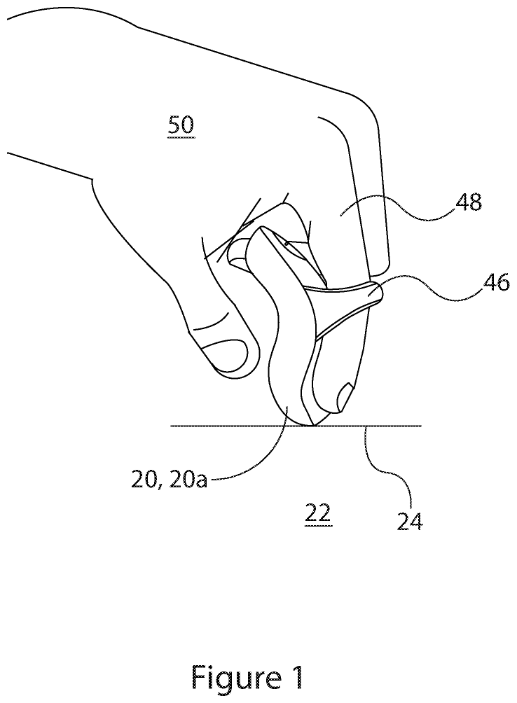

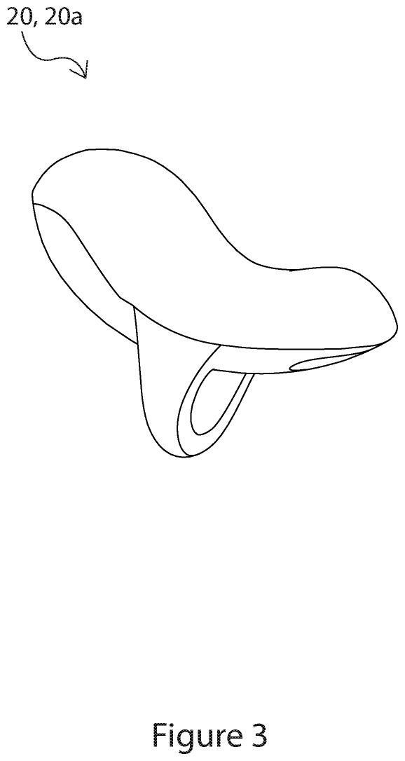

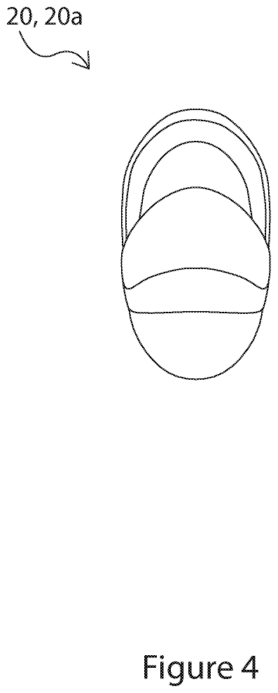

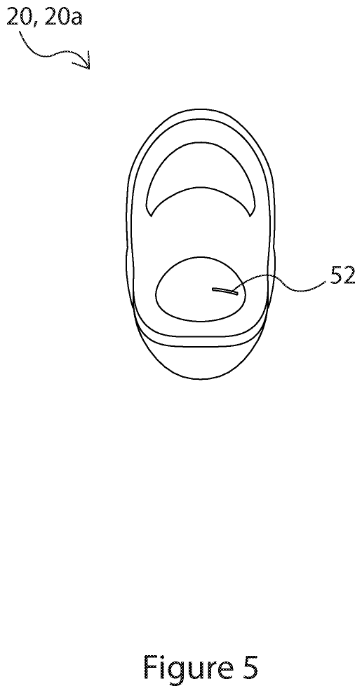

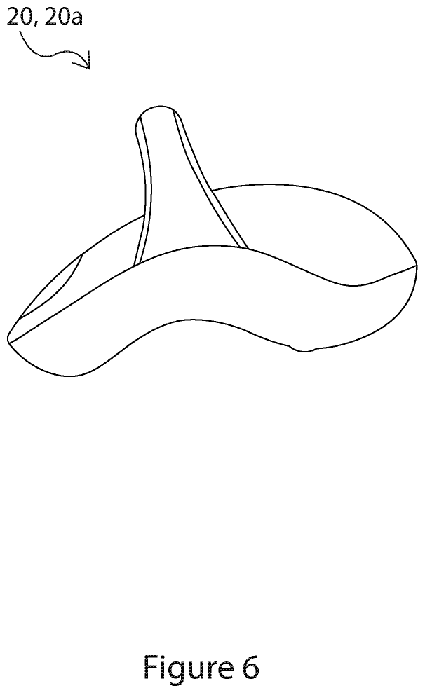

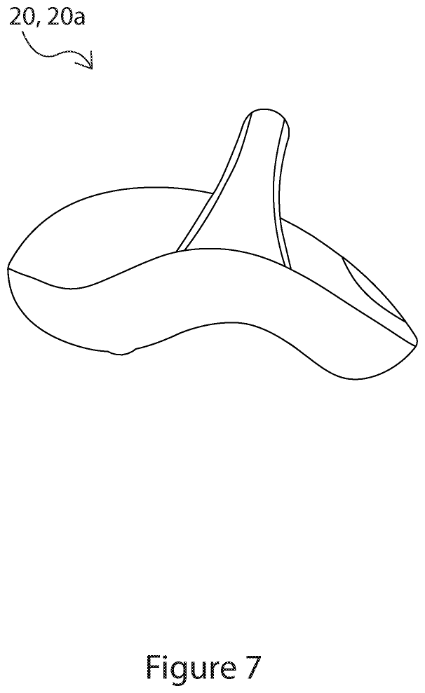

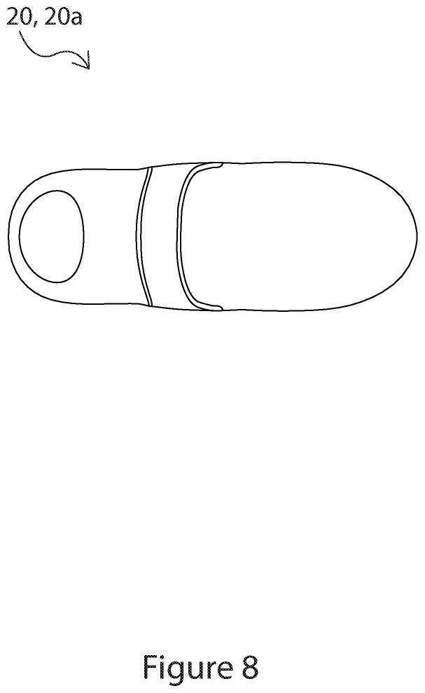

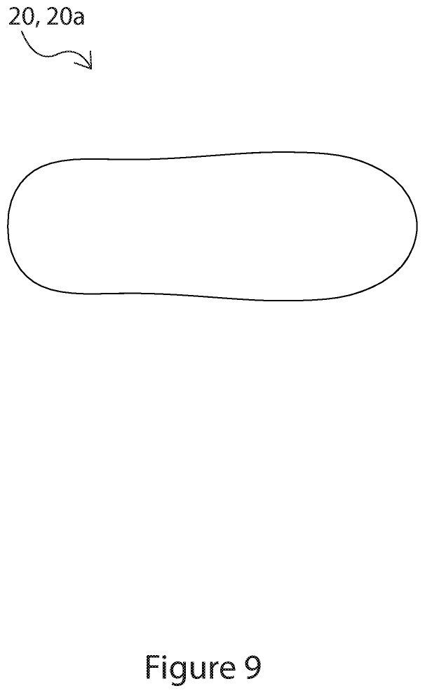

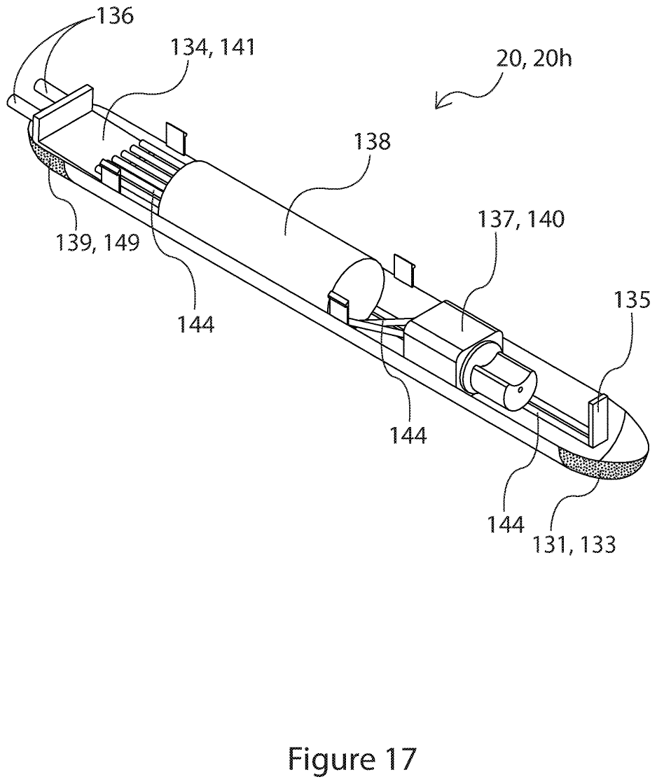

Devices 20 (20a-20h) for delivering a desired effect to a body 22 having skin 24 is illustrated in FIGS. 1-18. Device 20 may deliver a pleasurable effect, a therapeutic effect, and/or a healing effect. The desired effect is delivered by a desired response from the device. Pleasurable effects may include vibration, massage, etc. Therapeutic effects may include light, heat, etc. Healing effects may include current to a wound, chemical application to the skin, etc. Devices 20 may take the form of devices such as massagers, vibrators, light wands, electrolytic tools, male/female sex toys, self-heating wearables, medical monitors, sports products, hygiene, cosmetic devices, etc.

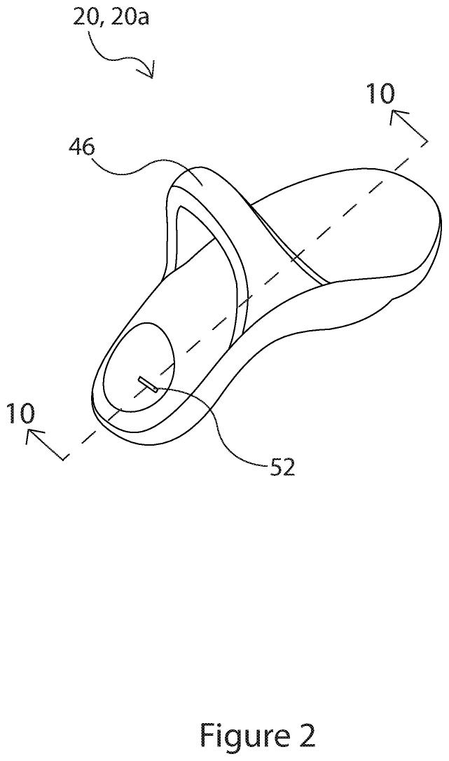

In one exemplary embodiment, FIGS. 1 and 2, proximity or skin touch activated device 20 is a finger massager 20a. Although the finger massager has a unique shape and delivers a vibration effect, the components and shape of this device can be altered and included in a multitude of other skin touch activated devices. These other proximity or skin touch activated devices (20b-20h) may have different shapes, components and structures that deliver other desired effects. Device 20, 20a comprises a housing 26. Housing 26 is ergonomically shaped to circumscribe a portion of a finger. Housing 26 may include a first cover 28a and second cover 28b that create a housing cavity 32. Housing cavity 32 holds several components that are integrated to work together. These components may include printed circuit board (PCB) 34, charging pole 36 (a.k.a., charging port), battery 38, motor 40. Capacitive switch 42 is also integrated with these components. Capacitive switch 42 may exist partly on the outside of housing 26, pass through the housing, and/or lie within the housing. Polymeric outer covering 44 may cover housing 26 to seal the housing and provide for a more ergonomic shape and feel. Polymeric outer covering 44 may have a level of conductivity that allows charge to be transmitted through this outer layer.

FIGS. 2-9 illustrate the ergonomic shape of finger massager 20a. Device 20, 20a is elongated and has a finger loop 46 that the user inserts their finger 48 to secure the device to their hand 50. The presences of the user's finger 48 within figure loop 46 does not activate the device, as capacitive switch 42 is insulated from the user by insulative layers such as housing 26 and polymeric outer covering 44.

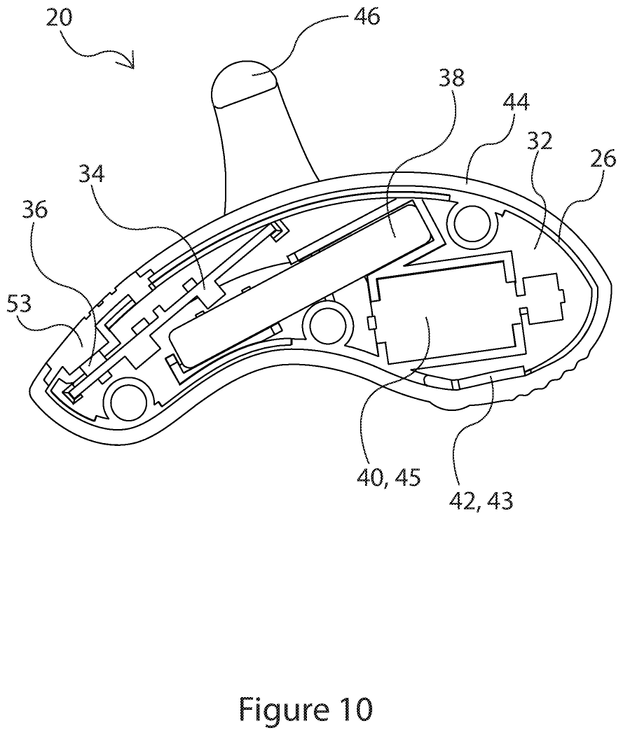

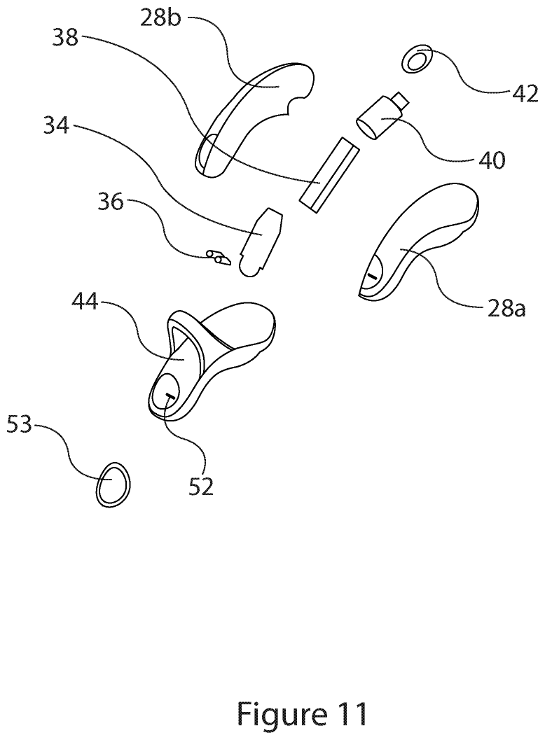

Integration of components is shown in FIGS. 10 and 11. Capacitive switch 42 may take the form of a metallic film/disc 43 just below the outer skin 44. Metallic disc 43 is electrically connected to PCB 34. Motor 40, one type of desired effect generating element 45, is located in this embodiment at the fingertip end of device 20a. Motor 40 or other desired effect generating elements 45 are also electrically connected to PCB 34. Motor 40 delivers vibrations when instructed by the PCB 34. Battery 38 provides power to PCB 34; the power is delivered to all components from the PCB. Charging pole 36 is integrated with PCB 34 and can receive power to charge battery 38 via a micro-USB port 52. Port cover 53 covers USB port 52.

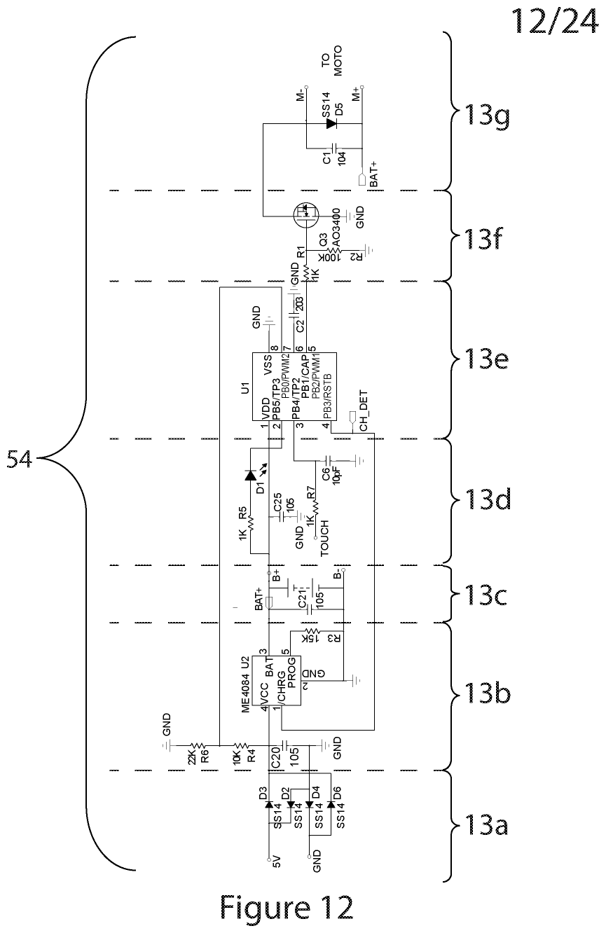

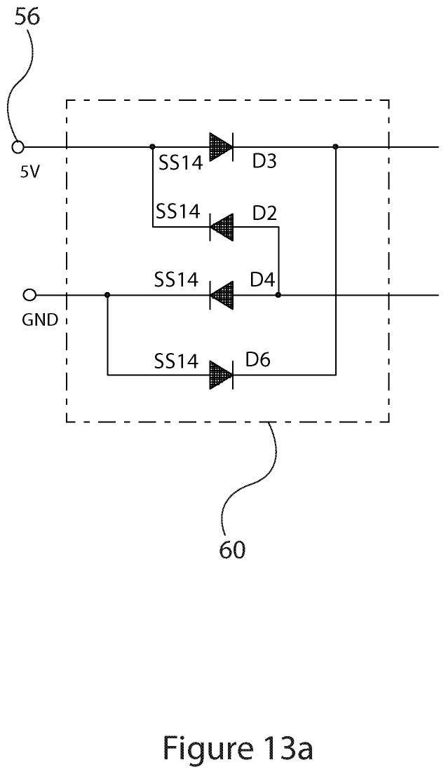

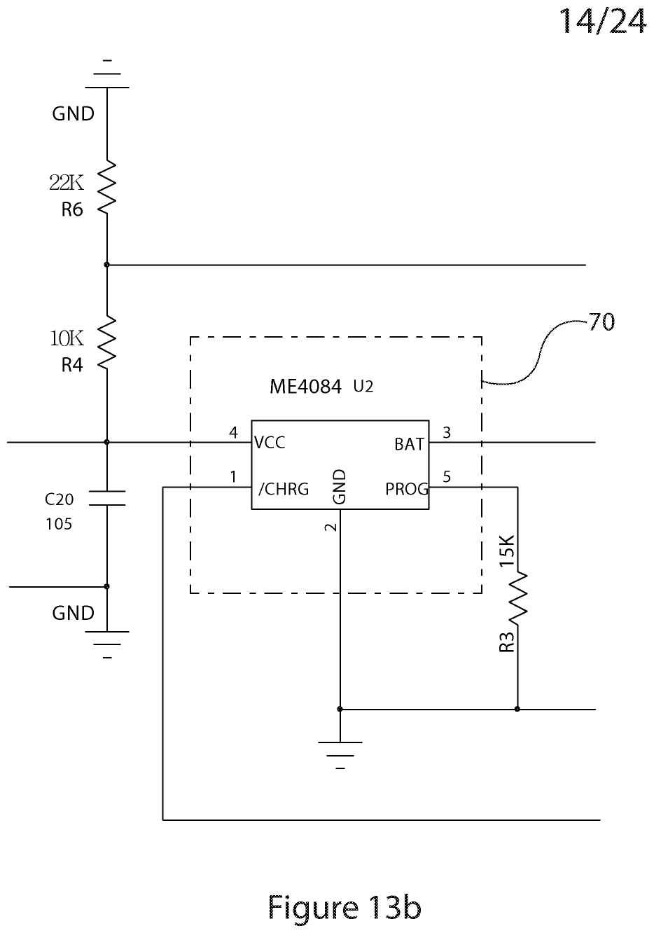

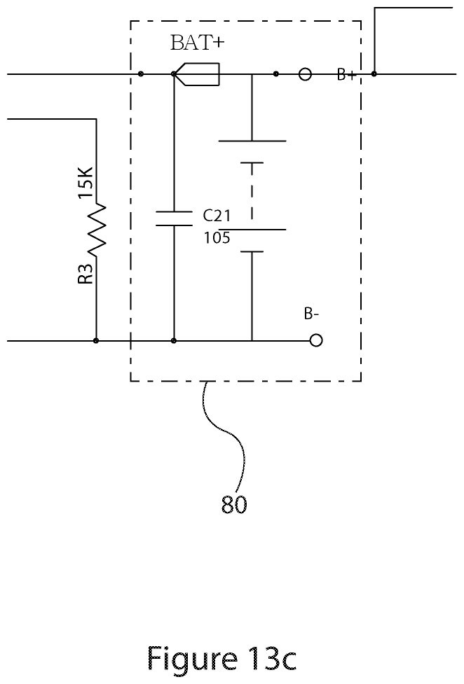

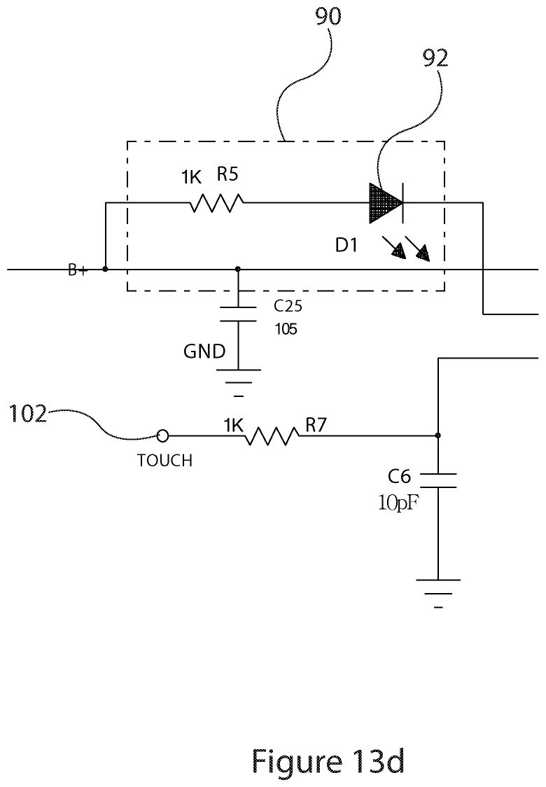

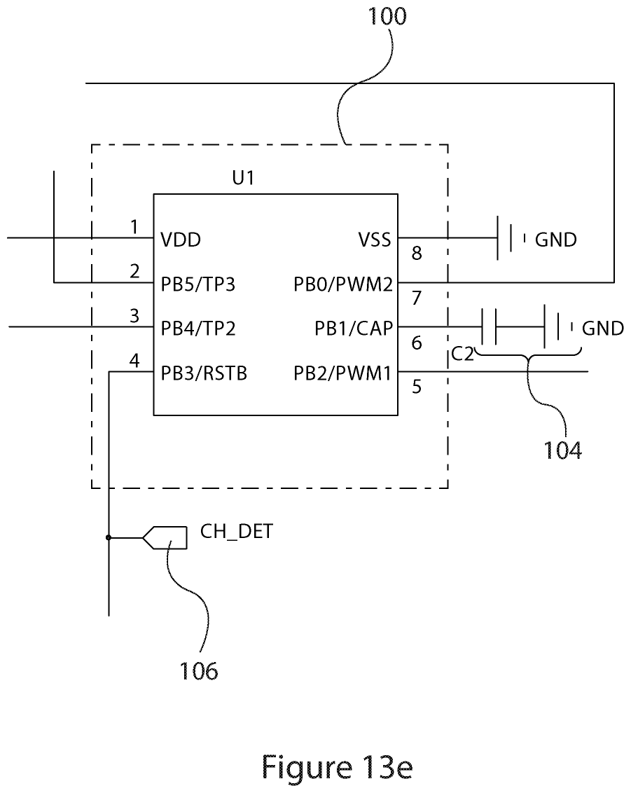

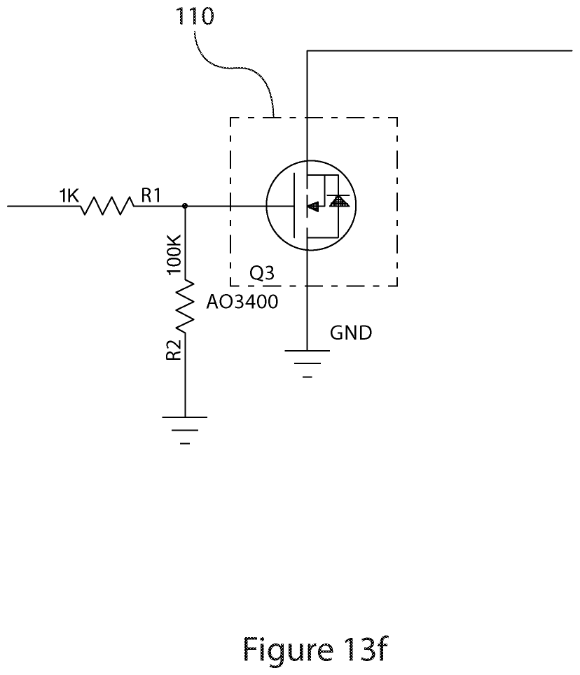

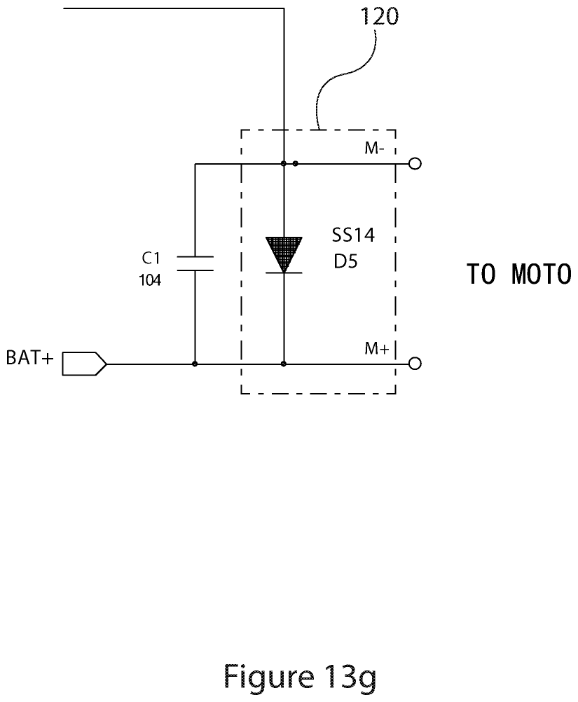

The overall control circuit 54 (a.k.a. discrimination circuit) for device (20, 20a) is illustrated in FIG. 12. This circuit 54 may also be applied to other embodiments of the device (20b-20h) and modified to integrate different desired effect generating elements 45. Enlarged views of different sections of control circuit 54 are illustrated in FIGS. 13a-13g. Operation of the control circuit 54 and the circuit's different components are as follows. Input power of 5 V DC is applied at 56. FIG. 13a illustrates magnetic rectifier circuit 60. FIG. 13b shows lithium battery charging integrated circuit (IC) 70. FIG. 13c illustrates lithium battery charging pole circuit 80. FIG. 13d illustrates LED circuitry 90 used to indicate recharging and working current for device 20. LED 92 indicates when device 20 is operating. LED 92 will flash when charging and exist as a solid glow after full charge. FIG. 13e illustrates touch contact micro controller unit (MCU) 100. Touch point 102 allows discharge capacitor 104 to discharge when metal film 43 of capacitive switch 42 is touched. Touching body 20, the skin will discharge capacitor 104 thereby providing current through circuit 54 and start the device working allowing desired effect generating element 45 to generate a desired response to be transmitted to body 22 and skin 24. However, sometimes a human body has static charge and when the body comes in very close proximity to the skin, the static charge will discharge capacitor 104 and start the device working. CH_DET 106 is used for charging and inspection. FIG. 13f illustrates the motor voltage control 110. FIG. 13g illustrates the power supply circuitry 120 of motor 40. When the capacitive switch 42 is taken away from the skin, discharge capacitor will recharge and turn device 20 off, the capacitive switch will be turned off and the desired effect generating element will be deactivated.

Although the example of a finger massager 20a is used to illustrate all of the basic components of the invention and how these components work together, the elements from the finger massager can be applied to other devices and provide for other desired effects. The motor 40 may be replace with other desired effect generating elements 45 such as light emitting diodes, heating elements, electrical current generators, chemical applicators, vibrators, etc. Further a microcontroller may be integrated with the desired effect generating element 45 to change between modes of operation. For example, when the housing is tapped upon a conductive surface the microcontroller instructs the desired effect generating element 45 to change to different effect outputs with each tap, e.g., a plurality of different vibration outputs.

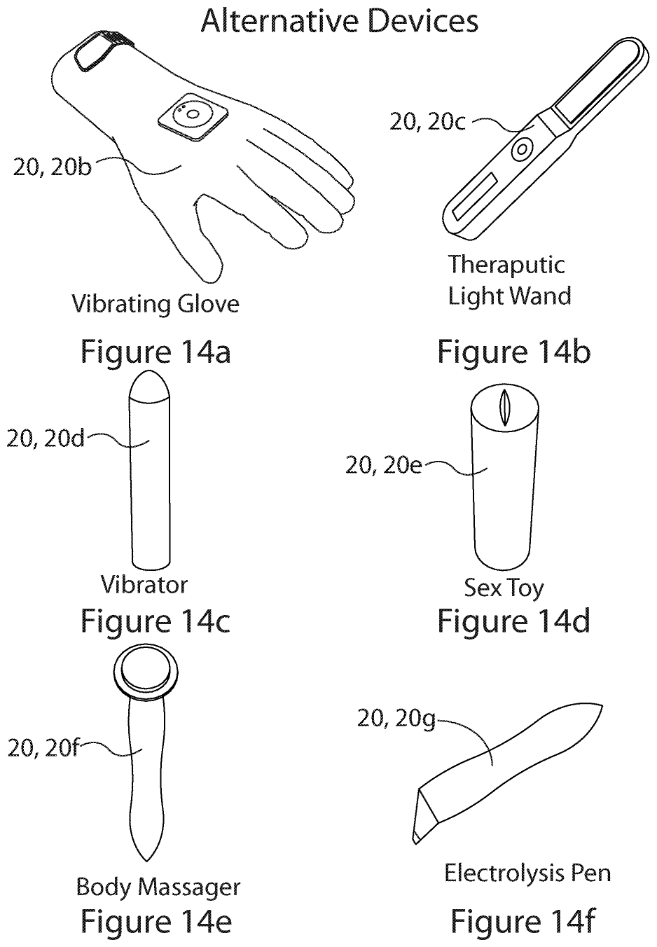

The physical shape of finger massager 20a, may be changed into different shapes and deliver different desired effects. These devices will all include the skin touch activation described above and may be integrated with different desired effect generating elements. For example, the skin touch actuation described above could be applied to a vibrating glove (20, 20b), FIG. 14a. Touch actuation could be integrated with therapeutic light wand (20, 20c), FIG. 14b. For example, therapeutic light wand 20c will activate in close contact with areas of the skin to provide UV light to treatment of the area, but not direct unwanted UV light towards eyes when removed from the skin. Touch activation might also be used to activate a vibrator (20, 20d), when the vibrator touches or is inserted into a portion of the body, FIG. 14c. Touch activation may also be used with sexy toys (20, 20e), such that the toy is activated when a portion of the body is inserted into the toy, FIG. 14d. Still further, touch actuation may be integrated with a face massager (20, 20f), FIG. 14e. Touch actuation may even be integrated with an electrolysis pen (20, 20g), so that only when touching the area to be treated is the current applied to the body.

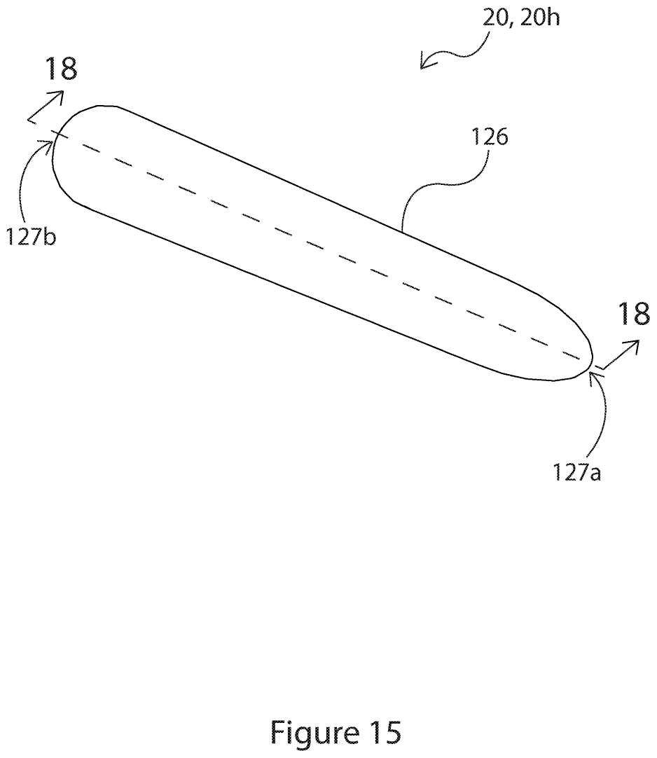

In another exemplary embodiment, FIGS. 15-18, skin touch activated device 20 is a vibrator 20h. Vibrator 20h may include any of the circuitry and components described prior. Although vibrator 20h has a unique shape and delivers a vibration effect, the components and shape of this device can be altered and include different desired effects. Device 20, 20h comprises a housing 126. Housing 126 includes a sensory end 127a and a gesture end 127b. Housing 126 may be an elongated housing. Sensory area and gesture control areas are specifically separated from each other respectively to sensory end 127a and gesture end 127b. In other embodiments, housing 126 may have a sensory area and a gesture control area that are not separated at different ends of the housing. Housing 126 may include a first cover 128a and second cover 128b that create a housing cavity 132. Housing cavity 132 holds several components that are integrated to work together. These components may include a discrimination sensor 133, discrimination circuit 135, desired effect generating element 137, gesture sensor 139, printed circuit board (PCB) 134, microcontroller 141, charging pole 136 (a.k.a., charging port), battery 138, motor 140. All components are connected electrically by wires 144. Polymeric outer covering 44 may cover housing 26 to seal the housing and provide for a more ergonomic shape and feel. Polymeric outer covering 44 may have a level of conductivity that allows charge to be transmitted through the outer skin layer.

Sensory area 131 is provided at sensory end 127a for vibrator 20h. Sensory area 131 defines the area of discrimination sensor 133. Sensory area 131 covers the entire sensory end of the housing. In other embodiments, sensory area may 131 on the base, front back, sidewalls, and midsection. Discrimination sensor 133 may be embedded under or behind a molded polymeric outer covering composed of non-conductive or selectively conductive materials such as silicone, thermoplastic elastomers (TPE), ABS plastic, elastane or polyurethane. Polymeric outer covering may serve to protect the internal components while maintaining responsiveness to pressure, proximity, or capacitive input through the overlaid material. The presence of an outer overlayer (a.k.a. polymeric outer covering) also supports hygienic use and ergonomic design, particularly for wearable or insertable applications.

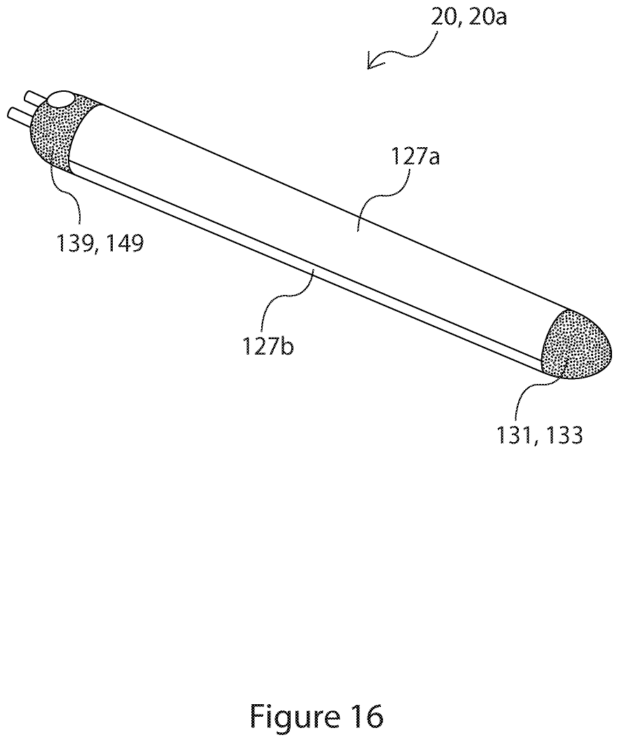

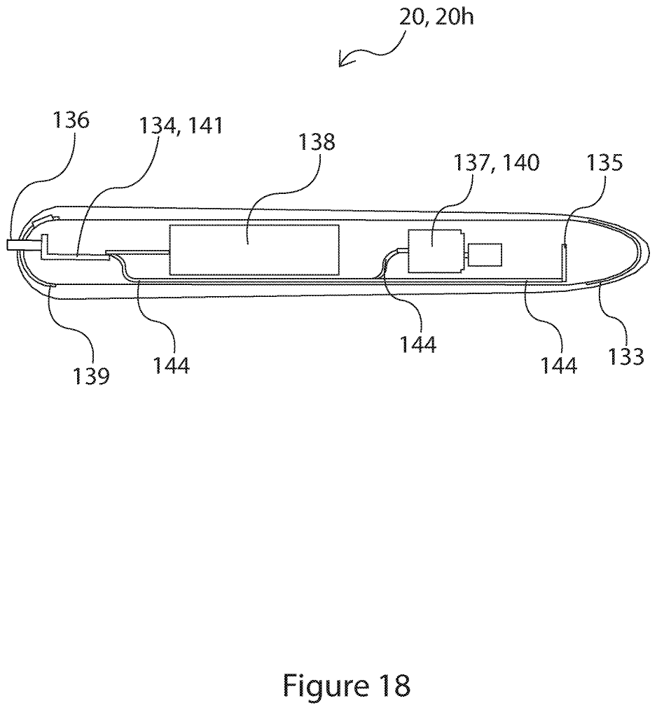

Discrimination sensor 133 senses physical properties of body 22 when the discrimination sensor is at least one from the group including close proximity or touching the body. Discrimination sensor 133 may generate physical property data about body 22. If discrimination sensor 133 is a capacitive switch 142, FIGS. 16 and 18, the capacitive switch 142 may exist partly on the outside of housing 26, pass through the housing, and/or lie within the housing. Discrimination sensor 133 is covered by polymeric outer covering 44. Discrimination sensor 133 may include sensors such as optical pulse, thermal, piezoelectric, resistive, pressures sensitive, infrared, inertial, vibration response, distributed area, conductive elastomers and flexible printed films, strain and elasticity, and combinations thereof. One exemplary sensor is optical pulse sensor where a minimum pulse quality score would be detected where the device only starts when the device sees a real fingertip pulse. Other objects such as a metal spoon, water stream, or countertop will never start the device. In another option a skin temperature sensor would be integrated with temperature stability. For example, the device starts only if the contact surface to the device is between 28 and 37° C. and stable for 0.5 seconds. Cold metal and room temperature water would fail to start the device. Physical property data may be charge, temperature, pressure, force, pulse, stretch, elasticity, color, etc.

Working together with discrimination sensor 133 is a discrimination circuit 135 electrically connected to discrimination sensor 133. Discrimination circuit may be part of a microcontroller 141 and incorporated into a PCB. Discrimination circuit 135 interprets the physical property data generated by discrimination sensor 133 and determines physical properties of the body. The discrimination circuit may include a microcontroller, processor, comparator, sensor interface, memory, timing circuit, analog to digital converter, or signal processing logic. The circuit receives sensor signals and data from the discrimination sensor and compares the sensed signal and data to one or more thresholds, ranges, stored profiles, or validation rules to determine whether the sensed surface corresponds to human skin.

Desired effect generating element 137 produces a plurality of desired effects. The desired effect is set to a unique desired effect based on the physical properties that were sensed by the discrimination sensor. Desire effect generating elements 137 may be a vibrator giving the desired response of vibration. Desired effect generating element 137 may produce therapeutic light, electrical current, heat, dispensing a chemical, vibration, air based, thrusting, and suction. Desired effect generating element 137 may also output information about the physical property data or what the physical body has been exposed to.

Gesture sensor 139 is integrated with gesture control end 127b sensing one or more gestures of the user, the gesture sensor integrated to generate gesture data. Types of gesture sensors include solid state, motion, force, optical, strain, elasticity, and other sensors. Gesture sensor may receive input wirelessly from a controller remote from the device. Gesture area 149 is provided at gesture end 127b for vibrator 20h. Gesture area 149 defines the area where gestures can be made to affect what desired effects are being provided. Gesture area 149 may cover the entire gesture end of the housing. In other embodiments, sensory area maybe anywhere on the device. Sensory area 131 and gesture control area 149 may be separate, overlapping, or formed as a common exterior.

Gesture sensor may be a capacitive sensing region on the exterior surface of housing/device, and all state changes are generated by tap gestures on the same region. No mechanical controls are needed. Control of device 20 is buttonless. Device 20 may include a touch-sensitive interface configured to activate the device by various gestures. The whole gesture sensor area 149 behaves like a control, no need for a button. Tapping at any discrete point within the gesture control area 149 acts like a switch to change desired effects within the device. The user tapes anywhere on the touch surface to cycle modes. Tap interface may be single-point or distributed, and may detect characteristics such as relative force, temperature, frequency, duration, motion, or other changes in surface contact. Gestures may include a single tap, double tap, triple tap, sliding motion and multi finger contact.

During operation discrimination sensor 133 is only activated as the sensor is brought in close proximity to or touches the body that will be receiving a desired effect. Discrimination sensor may be able to detect a body or its properties through a layer of clothing. The discrimination occurring is skin discrimination from other materials, bodies or objects that device 20 could inadvertently come in contact with. Discrimination senor 133 starts to acquire physical property data about the body. Discrimination sensor 133 may exist as a microcontroller 134 integrated with gesture sensor 139 and desired effect generating element 137. Desired effect generating element 137 is activated to generate a desired effect based on the physical property data and the gesture data provided to the microcontroller. For example, when housing is tapped upon a surface the microcontroller instructs the desired effect generating element to change to different desired effect outputs with each tap (i.e. gesture). The device may turn off when the capacitive switch moves away from the skin. A timing logic may be integrated toad a short delay after contact to the body ends to avoid nuisance shutoffs.

Although the device described are based on having no buttons to actuate, the device may include a mechanical control in addition to the non-mechanical input and activation.

Device 20 may be formed as a handheld massager, glove, sleeve, pad, cup, insertable device, or textile-integrated product. Device 20 may also be designed as a surface-mounted or body-affixed device, including products not manually held during use, or affixed via suction, straps, magnetic bases, adhesives, or anatomical fit. These configurations allow for both wearable and non-wearable implementations across therapeutic, sensory, or intimate use cases.

Categories and products where the technology of this disclosure could be used are: Rehabilitation and therapy technology, sports impact and safety, heated wearable products. medical monitoring, treatment and safety devices, oral and dental, sleep and respiratory, sports grip products, vehicle and driver safety, industrial and workplace safety, home and hygiene, wearable personal safety, stroke detection, and personal grooming and cosmetic devices.

While several embodiments of the invention, together with modifications thereof, have been described in detail herein and illustrated in the accompanying drawings, it will be evident that various further modifications are possible without departing from the scope of the invention. The scope of the claims should not be limited by the preferred embodiments set forth in the examples, but should be given the broadest interpretation consistent with the description as a whole.

What is claimed is:

1) A device for delivering a desired effect to a body having skin by a user; comprising:
a) a housing having a sensory end and a gesture control end; the sensory end having a sensory area;
b) a discrimination sensor electrically connected to the sensory area, the discrimination sensor sensing physical properties of the body when the discrimination sensor is at least one from the group including close proximity or touching the body; the discrimination sensor generating physical property data about the body;
c) a discrimination circuit electrically connected to the discrimination sensor interpreting the physical property data generated by the discrimination sensor and responding to physical properties of the body;
d) a desired effect generating element within the housing producing a plurality of desired effects;
e) a gesture sensor integrated with the gesture control end sensing one or more gestures of the user, the gesture sensor integrated to generate gesture data;
f) a polymeric outer covering over the housing, discrimination sensor, and gesture sensor; and
g) wherein the desired effect generating element is activated to generate a desired effect based on the physical property data and the gesture data.

2) The device as recited in claim 1, wherein the housing is an elongated housing with the sensory end and gesture ends rounded.

3) The device as recited in claim 1, wherein the sensory area covers the entire sensory end of the housing.

4) The device as recited in claim 1, wherein the gesture sensor is a solid-state sensor.

5) The device as recited in claim 1, wherein the gesture sensor is a motion sensor.

6) The device as recited in claim 1, wherein the discrimination sensor includes a capacitor, wherein the capacitor discharges when in close proximity to the skin.

7) The device as recited in claim 1, further comprising a microcontroller integrated with the gesture sensor and the desired effect generating element, whereby when the gesture is applied to the gesture control area of the housing the microcontroller instructs the desired effect generating element to change to different effective outputs with each gesture.

8) The device as recited in claim 1, wherein the desired effect generating element is a vibrator.

9) The device as recited in claim 1, further comprising a battery and charging port.

10) The device as recited in claim 1, wherein the desired response is vibration.

11) The device as recited in claim 1, wherein the desired response is light.

12) The device as recited in claim 1, wherein the desired response is electrical current.

13) The device as recited in claim 1, wherein the desired response is heat.

14) The device as recited in claim 1, wherein the desired response is dispensing of a chemical.

15) The device as recited in claim 1, wherein the discrimination circuit compares the sensed data to a validation rule to determine whether the sensed surface corresponds to human skin.

16) The device as recited in claim 1, wherein the desired effect is automatically set to a unique desired effect based on the physical properties that were sensed by the discrimination sensor.

17) The device as recited in claim 1, wherein the device is activated only after skin discrimination and buttonless gesture control have both been satisfied.

18. A device for delivering a desired effect to a body having skin by a user; comprising:
a) a housing having a sensory area and a gesture controller;
b) a discrimination sensor integrated with the sensory area, the discrimination sensor sensing physical properties of the body when the discrimination sensor is at least one from the group including close proximity or touching the body; the discrimination sensor generating physical property data about the body;
c) a discrimination circuit electrically connected to the discrimination sensor interpreting the physical property data generated by the discrimination sensor and determining physical properties of the body;
d) a desired effect generating element within the housing producing a plurality of desired effects;
e) a gesture sensor integrated with the gesture controller sensing one or more gestures of the user, the gesture sensor integrated to generate gesture data;
f) a polymeric outer covering over the housing; and
g) wherein the desired effect generating element is activated to generate a desired effect based on the physical property data and the gesture provided.

19. A device for delivering a desired effect to a body having skin by a user; comprising:
a) a housing having a sensory area and a gesture controller;
b) a desired effect generating element within the housing producing a plurality of desired effects;
c) a gesture sensor integrated with the gesture controller sensing one or more gestures of the user, the gesture sensor integrated to generate gesture data; and
d) wherein the desired effect generating element is activated to generate a desired effect based on the gesture data provided.
